(19) United States
(12) Patent Application Publication
(10) Pub. No.: US 2005/0169450 A1
(43) Pub. Date: Aug. 4, 2005

(54) Method of automatically accessing a telephone conference, and a system for implementing the method

(76) Inventors: Jean-Pierre Blin, Clamart (FR); Charalambos Koutsoumalis, Verrieres Le (FR); Anne-Francoise Chivot-Gain, Issy Les Moulineaux (FR)

Correspondence Address: MCDERMOTT WILL & EMERY LLP;ATTN: INTELLECTUAL PROPERTY DEPTARTMENT DOCKETING, 28 STATE STREET, BOSTON, MA, 02109, US

(21) Appl. No.: 10/949,440

(22) Filed: Sep. 24, 2004

(30) Foreign Application Priority Data
Sep. 26, 2003 (FR) 0311326

(51) Int. Cl. H04M 3/42

(52) U.S. Cl. 379/202.01

(57) ABSTRACT

This method of accessing a telephone conference bridge that corresponds to a specific physical call number comprises: a client calling a special number corresponding to a telephone conference service, which number is common to a set of telephone conferences; transferring the call to a service control point; setting up a call between the client and an intelligent peripheral under the control of the service control point; the client sending an access code to the intelligent peripheral, which access code is specific to the telephone conference bridge; the intelligent peripheral forwarding the conference bridge access code to the service control point; the service control point determining which conference bridge corresponds to the supplied access code and allocating the corresponding physical call number to the call; and a call being set up between the client and the determined conference bridge.

The invention relates to telephone conferences or multipoint video conferences, and it relates more particularly to the system for accessing such conferences.

### BACKGROUND OF THE INVENTION

The term “telephone conference” is used to refer to the possibility of enabling more than two people to converse by telephone, in which case the conference is said to be an audio conference, or to converse and view one another using video phones or video conference rooms, in which case the conference is referred to as a video conference.

When the number of parties involved is equal to three, it is common to refer to a “three-party” conference.

Such three-party conferences are commonly used by businesses making use of facilities made available by their private automatic telephone exchanges (PABXs). However, a conference can also be implemented by a public exchange, and certain fixed or mobile network operators enable their clients to set up conferences of this type.

It is generally very simple to set up a conference with a digital terminal since it suffices to put the other party on hold, to call a third party, and then once the third party has answered, to press the “conference” button on the terminal in order to establish a three-party conversation. With an analog terminal, the actions required are hardly any more complicated, involving pressing digit keys instead of dedicated keys.

Starting from a three-party conference, it is often possible to add other parties. Nevertheless, that process suffers from two major drawbacks: the new party must be available at the time the call is made, and audio quality becomes degraded very quickly with increasing number of parties, since each party can hear all of the noise coming from each of the lines.

Consequently, equipment commonly known as a conference bridge has been designed for remedying such drawbacks.

The function of a conference bridge is to mix the various channels corresponding to the number of parties while also performing a certain amount of signal processing so as to cancel echo phenomena and improve signal-to-noise ratio in order to make listening comfortable. Such equipment also includes all of the transmission and signaling functions needed to enable it to connect with the network.

At present, the use of conference bridges, and thus of the associated conference services, takes place as follows.

The parties organize a time and date for a rendezvous so that all of them are available at the same time to join in the conference.

One of the parties then reserves a conference bridge resource with an operator. The operator then issues a call number, possibly together with a secret code that the parties need to use in order to join the conference.

Alternatively, one of the parties may have a permanent subscription to a conference bridge resource, thus enabling that party to organize a conference at any time. The call number, and possibly also the access code, are given to the party when taking out the subscription.

The above also applies to a video conference for which specific conference bridges and associated services have been developed for fixed networks (integrated services digital network (ISDN), public switched telephone network (PSTN)) and also for mobile networks (International Telecommunications Union standardization section (ITU-T) recommendations H 320, H 324, H 324M).

A drawback of the above-described technique is the number of digits that a user needs to dial in order to access the telephone conference service. The user must begin by dialing an access number that fits into the national numbering scheme, e.g. ten digits in France since the year 2000. If a secret code is used in order to prevent unauthorized parties from joining the conference, the user must then dial four to six more digits.

In order to keep down the number of digits that the caller needs to dial, certain operators hide a password in the number given on reservation. This requires the operator to reserve ranges of specific numbers that are large compared with the expected traffic. Typically, 100,000 numbers are needed for potential traffic of 1000 simultaneous channels. There must be very small chance of a client attempting to reuse a number that was allocated for a given time on a given day being able to join the conference of some other client on a later day.

A second drawback of the present technique lies in the connection between a given number and a conference bridge. Consequently, the operator cannot change the number, e.g. mnemonically in order to make it easy to remember in the context of a given commercial campaign. And when the operator has a plurality of conference bridges, the operator can balance loading between them only at the time when the access number is given to a client, i.e. well before the moment of use: this means that the operator cannot respond to an unplanned event such as a breakdown, or heavy usage by subscribing users, in order to distribute conferences in some other way over that operator's various pieces of equipment.

Another drawback of the present technique lies in managing access codes. These are allocated for a given number and are thus associated with a given conference bridge. Changing the available access codes thus requires the operator to take action on each piece of equipment.

### OBJECTS AND SUMMARY OF THE INVENTION

An object of the invention is thus to eliminate the above-mentioned drawbacks by decoupling the call number and the secret code from the conference bridge.

Another object of the invention is to enable the client to use a secret code selected by the client from a list of available secret codes, e.g. for mnemonic purposes.

The invention provides a method of accessing a telephone conference bridge, which bridge corresponds to a specific physical call number, the method comprising the steps of:
a client calling a special number corresponding to a telephone conference service, and common to a set of telephone conferences;
transferring the call to a service control point;
setting up a call between the client and an intelligent peripheral under the control of the service control point;
the client sending an access code to the intelligent peripheral, which access code is specific to the telephone conference bridge;
the intelligent peripheral forwarding the conference bridge access code to the service control point;
the service control point determining the conference bridge that corresponds to the supplied access code, and giving the corresponding physical call number to the call; and
setting up a call between the client and the determined conference bridge.

The invention also provides a telephone conference bridge access system for implementing the method and comprising:
a service control point suitable, on receiving a call coming from a client and made to a special number corresponding to a telephone conference service, for causing a call to be set up between an intelligent peripheral and the client;
the intelligent peripheral which is suitable for asking the client for an access code specific to the conference bridge and for forwarding said access code to the service control point; and
a plurality of conference bridges associated with the service control point;
the service control point also being suitable for determining the conference bridge that corresponds to the access code as supplied, for allocating the corresponding physical call number to the call, and for controlling the setting up of a call between the client and the determined conference bridge.

The invention also provides software installed on the dedicated equipment enabling the above-described method and system to be implemented.

### BRIEF DESCRIPTION OF THE DRAWINGS

The invention will be better understood on reading the description and on observing the following drawings, in which:

FIG. 1 shows the architecture of an intelligent network that is known in the prior art;

FIG. 2 shows the architecture of an intelligent network having a plurality of conference bridges connected thereto;

FIG. 3 is a flow chart showing how the method of the invention is implemented; and

FIG. 4 shows a message in accordance with the “user-to-user signaling” standard of the intelligent network application part (INAP) and shows the extraction of data therefrom into an ISDN message.

### MORE DETAILED DESCRIPTION

Since the invention makes use of intelligent network (IN) concepts as described in the ITU-T recommendations mentioned above, the description below relates only to those elements that are necessary for understanding the invention, with reference to the concepts and definitions included in those recommendations.

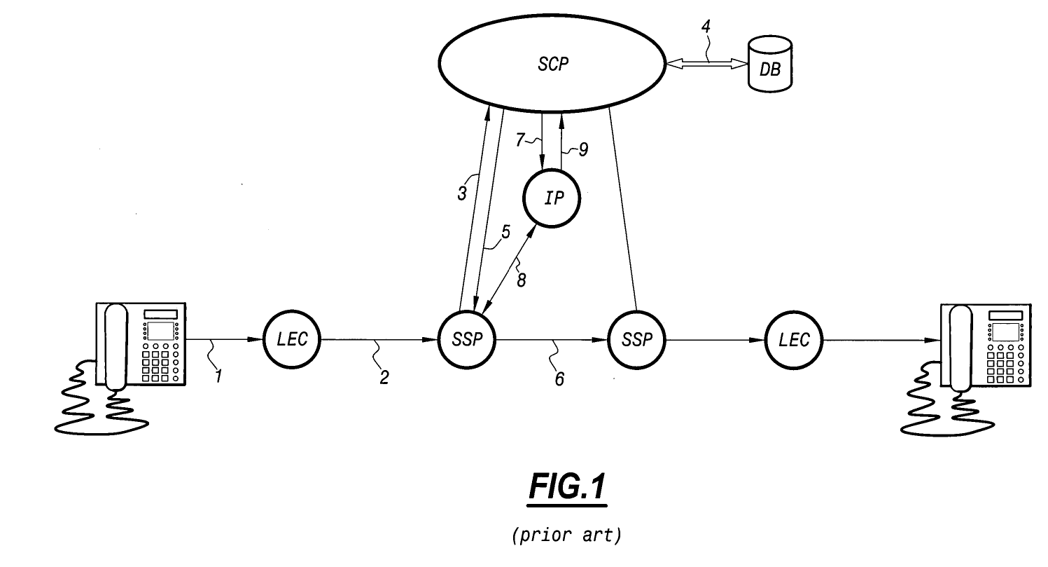

On the basis of FIG. 1, a typical service for intelligent networks is described, specifically a service for handling special numbers.

An intelligent network thus comprises local access switches known as local exchanges (LEC) which are connected directly to user terminals. If a received call is not a local call, it is directed to transit switches known as service switching points (SSP) which set up a path to the LEC of the called party. The LEC is then in charge of setting up the connection thereto.

In France, the “green number” service which allows a caller to make a free call, or indeed the handling of short numbers (with the exception of emergency service numbers (e.g. 112, the European emergency number), which numbers are handled directly by LECs), rely on translating a logical number 3BPQ of determined structure (e.g. 0800 in France for free numbers) into a real destination number. This translation data forms part of a table which must be common for all switches.

When the local access switch receives (1) a call from a caller using a logical number 3BPQ, the switch transfers (2) the call to the transit switch SSP, since the logical number 3BPQ is not a local number.

When the dialed number is detected as being a 3BPQ number by the SSP, it stops all processing relating to the call, and while reserving the communications channel between itself and the caller, it requests (3) instructions from a service control point (SCP). The SCP is a single point which handles the table for translating numbers and to which all of the switches are connected. The SCP then searches (4) through its tables for the physical number to which the call is to be redirected as a function of the selected logical number, and possibly also as a function of particular criteria such as the day of the week, the time of day, or the location from which the call originates. Once the physical number has been found, the SCP informs (5) the SSP that it is to set up a connection to such a physical number. The SSP then sets up (6) the call in conventional manner.

The SSP thus receives instructions from the SCP and carries them out.

In that architecture, the SCP thus acts as a master while the SSPs are slaves.

Such a service is listed in capability set CS-1 of UIT-T recommendation Q 1211 in the group “number translation services”.

In certain types of service offered by the intelligent network, it can be necessary to set up interaction with the user. This applies to services of the “call center” type in which the user is directed to such and such an operator as a function of the type of question to be solved. To do this, the intelligent network has intelligent peripherals (IPs) which act (7 and 9) under the instructions of the SCP to set up such interaction. Very often, the IPs are voice servers.

Under such circumstances, the SCP sends (7) a specific command to the intelligent peripheral IP and in parallel requests the SSP to set up the call between the caller and the intelligent peripheral IP.

The intelligent peripheral IP then acts (8) to set up a dialog with the caller so as to obtain the necessary parameters.

Once the dialog has been completed, the intelligent peripheral IP sends (9) these parameters to the SCP so that it can determine (4) the corresponding physical number and return the call with the caller to the transit switch SSP.

The SCP sends (5) the physical number it has determined to the SSP, which can then set up (6) the requested call.

According to a remarkable aspect of the method of the invention, the supplier of telephone conference services applies to the organization responsible for the national numbering plan for a specific short number that is to be used by all people seeking to access a telephone conference.

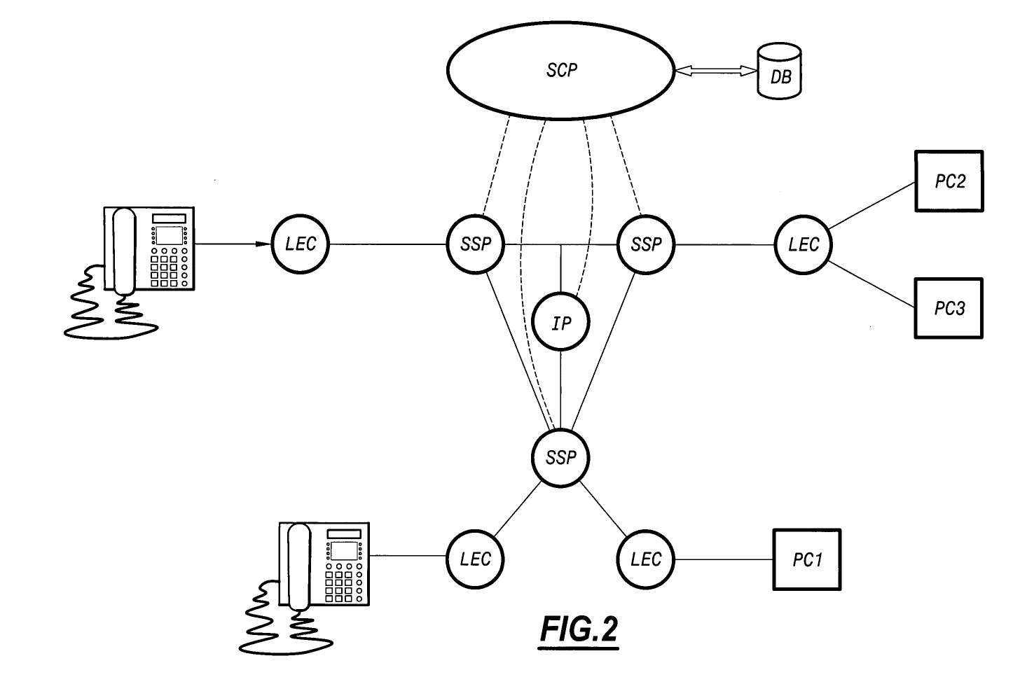

As shown in FIG. 2, the conference service supplier also has a certain number of conference bridges PC1, PC2, and PC3 connected to the intelligent network and having specific physical numbers allocated thereto.

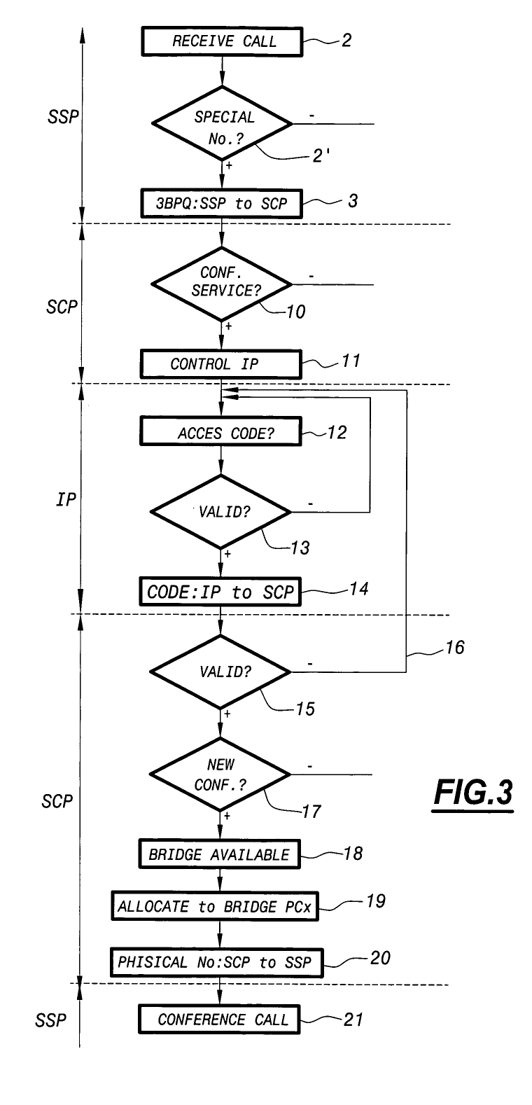

The method of the present invention then consists, see FIG. 3, in making use of the mechanisms of the intelligent network as described above, to cause the SSP to detect (2′) that the dialed number is a special number, and to then transfer (3) the call using the telephone conference short number to the corresponding service hosted by the SCP. On receiving the call, the SCP determines (10) that the number corresponds to the telephone number service.

Since the number called, of the type 3BPQ, corresponds to a set of telephone conferences, it is necessary for the SCP to determine which conference is requested.

To do this, the SCP causes (11) a call to be set up between the caller and an intelligent peripheral IP. For example, the SCP supplies the intelligent peripheral with the number of the caller.

The intelligent peripheral IP then requests (12) the caller, e.g. by means of a voice dialog, to give the number for accessing the conference in which the caller seeks to participate.

It should be observed that the intelligent peripheral IP can perform initial validation (13) of the dialed access code, e.g. by verifying the number of digits making it up, and can engage in correcting dialog with the caller in the event of an error.

Once the intelligent peripheral IP has detected a correct code, it forwards (14) the code to the SCP. The SCP can then perform (15) a second check to determine whether the code has been given properly. In the event of an error, the SCP sends (16) a command to the intelligent peripheral IP to continue dialog and obtain a code that is valid.

When the access code is correct, the call between the caller and the intelligent peripheral is interrupted.

During the following step of the method of the invention, the SCP determines (17) whether the call corresponds to a new conference that needs to be opened or whether it corresponds to an existing conference that is on-going.

If the conference is already in existence on a conference bridge, the SCP gives the call physical number corresponding to said conference bridge, and instructs (20) the SSPs to set up (21) the corresponding call, as described above.

If the call corresponds to opening a new conference, the SCP interrogates (18) the conference bridges to determine availability. Depending on availability, and on other parameters set by the operator; the SCP then allocates (19) the conference to a determined conference bridge, and thus to a determined physical number, and instructs (20) the SSPs to set up the corresponding call 21. In parallel, the SCP sends an open-conference command to the selected conference bridge.

In a remarkable variant of the method of the invention, the conference bridges responds to the open-conference command by returning to the SCP the number of available channels that remain. The SCP, made aware in this way of the number of available channels on all of the conference bridges, can allocate a new conference to a conference bridge without needing to interrogate the bridges specifically.

Calls between the various elements of the intelligent network are governed by the INAP signaling standard whose protocols are well known to the person skilled in the art, so it is unnecessary herein to describe how they are implemented in detail.

A remarkable aspect of the invention bears on using the INAP protocol to enable the SCP to communicate with the conference bridges.

It is well known that the INAP protocol is limited to within the intelligent network, and also that the intelligent network communicates with external elements such as subscriber exchanges (PABXs) using ISDN subscriber signaling (ITU-T standard Q 931).

The method of the present invention must thus convert INAP standard messages into ISDN standard messages in order to enable the SCP and the conference bridges to communicate.

Remarkably, the method of the present invention makes use of the “user-to-user signaling” code of the INAP standard to enable the SCP to communicate with the conference bridges.

The “user-to-user signaling” code enables instructions and/or data to be transferred between the intelligent network and an external peripheral such as a PABX or a conference bridge capable of understanding the ISDN standard.

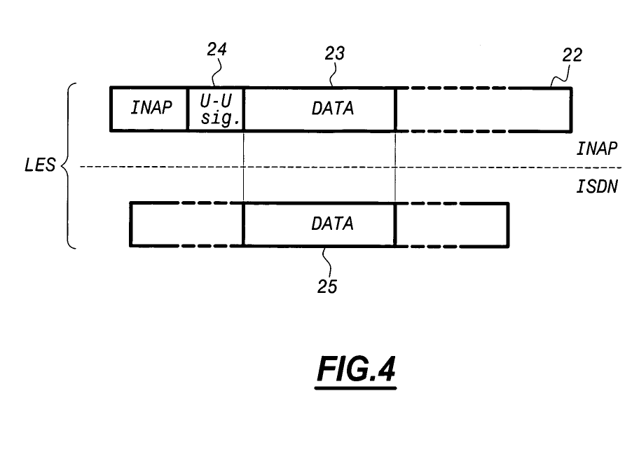

The instructions given (23, FIG. 4) are encapsulated in an INAP message 22 as the data of the message. The message has a specific header 24 indicating that it is of the “user-to-user signaling” type.

On reception, the LES that provides the interface with said external equipment, recovers the data 23 from the “user-to-user signaling” INAP message and transfers it to the equipment in the form of an ISDN signaling message 25.

Naturally, this change of protocol can be performed in the opposite direction. On the external equipment sending a message, the LES encapsulates the message in a “user-to-user signaling” INAP message for transfer to the appropriate equipment.

This use of INAP and ISDN signaling is not limiting on the generality of the invention, since the person skilled in the art will have no difficulty in transposing the invention as described above into the context of some other signaling, such as the signaling system known as CCITT No. 7.

It should be observed that by means of the method of the invention, the supplier can decide to organize the set of conference bridges in a distributed architecture in which a conference bridge is dedicated to a given zone, with a given physical number, or in an architecture that is centralized in which all of the calls from parties are transmitted to a central server which acts firstly to welcome parties and secondly to share traffic over the various conference bridges, or indeed in an architecture that is a combination thereof having a set of islands each comprising a plurality of conference bridges. The invention makes it possible to select an architecture and to modify it in the best interests of the operator without clients perceiving any difference, with differences being hidden by the corresponding service of the SCP, and with only the parameters of the SCP varying to match changes in the architecture of conference bridges.

Another remarkable aspect of the invention is centralizing access codes to telephone conferences on the database of the SCP.

In the method of the invention, the access code is the sole means for singularizing a given telephone conference, since all of the conferences are called by users using the same call number. The SCP thus handles these access codes and the correspondence between them and telephone conferences.

This enables conferences to be handled extremely flexibly. This centralization of access codes allows the operator to define innovative services in the attribution of these codes, for example giving clients the possibility to select a code from a list of available codes.

In remarkable manner, the access code can thus be identical with the physical telephone number of the organizer.

In remarkable manner, the method of the present invention enables the intelligent peripheral IP to be used to define a mnemonic code. By dialing the telephone conference service number, the caller is brought into dialog with an intelligent peripheral IP as explained above. Then, for example, the peripheral can offer a choice between accessing a conference and reserving an access number. If the caller chooses to access a conference, the intelligent peripheral requests the caller's access code and the method continues as described above.

If the caller chooses to reserve a number, then the intelligent peripheral IP engages in dialog with the caller so as to enable the caller to choose a valid number. In a particular implementation of the invention, the SCP initially provides the intelligent peripheral IP with a list of numbers that are valid and available.

1. A method of accessing a telephone conference bridge, the bridge corresponds corresponding to a specific physical call number, the method comprising:
a client calling (2) a special number corresponding to a telephone conference service, and common to a set of telephone conferences;
transferring (3) the call to a service control point;
setting up (11) a call between the client and an intelligent peripheral under the control of the service control point;
the client sending (12) an access code to the intelligent peripheral, the access code being specific to the telephone conference bridge;
the intelligent peripheral forwarding (14) the conference bridge access code to the service control point;
the service control point determining (19) the conference bridge that corresponds to the supplied access code, and giving (20) the corresponding physical call number to the call; and
setting up (21) a call between the client and the determined conference bridge.

2. The method according to claim 1, further comprising:
the service control point allocating an available conference bridge to the conference after determining the availabilities of a plurality of conference bridges, if the call from the client corresponds to a new conference that is to be opened.

3. The method according to claim 1, further comprising:
the service control point validating the conference access code, and if the code is valid, interrupting the call between the client and the intelligent peripheral.

4. The method according to claim 3, further comprising:
the service control point sending an instruction to the intelligent peripheral to continue with the call and obtain an access code that is valid, in the event of the access code not being valid.

5. The method according to claim 1, further comprising:
a conference organizer reserving a conference access code;
establishing a dialog between the caller and the intelligent peripheral after the special number corresponding to the telephone conference service has been dialed by the organizer; and
the organizer choosing the access code.

6. The method according to claim 5, wherein the access code is chosen from the group consisting of: a code selected from a list of available access codes; and a usual call number of the organizer.

7. A system for accessing a telephone conference bridge comprising:
a service control point (SCP) configured, upon receiving a call coming from a client and made to a special number corresponding to a telephone conference service, for causing a call to be set up between an intelligent peripheral (IP) and the client;
the intelligent peripheral (IP) configured for asking the client for an access code specific to the conference bridge and for forwarding said access code to the service control point; and
a plurality of conference bridges (PC1, PC2, PC3) associated with the service control point (SCP);
the service control point (SCP) also being configured for determining the conference bridge that corresponds to the access code as supplied, for allocating the corresponding physical call number to the call, and for controlling the setting up of a call between the client and the determined conference bridge.

8. The system according to claim 7, wherein the service control point is configured: firstly for determining the availabilities of the conference bridges; and if the call from the client corresponds to a new conference that is to be open, secondly for allocating the conference to an available conference bridge.

9. The system according to claim 7, wherein the intelligent peripheral is a voice server.

10. A computer readable medium having a plurality of instruction stored thereon that, when executed by a processor, cause the processor to:
transfer (3) a call to a service control point, in response to a client calling (2) a special number that corresponds to a telephone conference service, and common to a set of telephone conferences;
set up (11) a call between the client and an intelligent peripheral under the control of the service control point;
forward (14) a conference bridge access code to the service control point, in response to the client sending (12) the access code to the intelligent peripheral, wherein the access code is specific to the telephone conference bridge;
determine (19) the conference bridge that corresponds to the supplied access code, and giving (20) the corresponding physical call number to the call; and
set up (21) a call between the client and the determined conference bridge.
